(19) United States
(12) Patent Application Publication
(10) Pub. No.: US 2018/0250656 A1
(43) Pub. Date: Sep. 6, 2018

(54) FUNCTIONALIZED SIO2 MICROSPHERES FOR EXTRACTING OIL FROM PRODUCED WATER

(71) Applicant: KING ABDULLAH UNIVERSITY OF SCIENCE AND TECHNOLOGY, Thuwal (SA)

(72) Inventors: Himanshu MISHRA, Thuwal (SA); A.S.F. FARINHA, Thuwal (SA); Shahnawaz SINHA, Thuwal (SA)

(21) Appl. No.: 15/758,151

(22) PCT Filed: Sep. 8, 2016
(86) PCT No.: PCT/IB2016/055358

§ 371 Date: Mar. 7, 2018

Related U.S. Application Data
(60) Provisional application No. 62/215,794, filed on Sep. 9, 2015.

(51) Int. Cl. B01J 20/10; B01J 20/28; B01J 20/32; C02F 1/28

(52) U.S. Cl. CPC B01J 20/103; B01J 20/28004; B01J 20/28019; C02F 2101/32; B01J 20/3246; C02F 1/288; B01J 20/3217

(57) ABSTRACT

Functionalized material, methods of producing the functionalized material, and use thereof for separation processes such as but not limited to use for separating and extracting a dissolved organic foulant, charged contaminant or oily matter or any combination thereof from water, such as produced water, are provided. In an embodiment, the functionalized material is a mineral material, such as mica, silica (e.g. an SiO2 microsphere) or a metal oxide, and the outer surface of the material is functionalized with an alkyl chain or a perfluorinated species. In an embodiment, the method of making the functionalized material, includes: a) providing a mineral material; b) providing an alkyl chain and/or a perfluorinated species, the alkyl chain or perfluorinated species selected to dissolve organic foulants, charged contaminants or oily matter from water or any combination thereof; c) hydroxylating the material via a concentrated acid solution or a basic solution; and d) grafting the alkyl chain and/or the perfluorinated species onto the material via a silanation reaction.

### CROSS-REFERENCE TO RELATED APPLICATIONS

This application claims the benefit of and priority to U.S. Provisional Application Ser. No. 62/215,794, having the title “FUNCTIONALIZED SiO₂ MICROSPHERES FOR EXTRACTING OIL FROM PRODUCED WATER,” filed on Sep. 9, 2015, the disclosure of which is incorporated herein in by reference in its entirety.

### TECHNICAL FIELD

The present disclosure generally relates to removal or separation of oil from produced water, in particular using modified microspheres for the removal.

### BACKGROUND

The oil and gas (O&G) industry handles exceedingly large volume of water every day. The water produced from O&G extraction is known as produced water (PW). Commonly a three-phase separator is used by the O&G industry, primarily in separating oil, gas and water at the production site. Water from this separator remains but with large (>1000 mg/L) to moderate (<50 mg/L) quantity of oils in the water.

Currently, O&G industry employs decades-old technologies post the three-phase separator for PW treatment, such as Inclined Plate Settlers, Gas Floatation and Nutshell Filters. These technologies primarily remove particulate matter and suspended oil from PW. They are less effective than desired in removing the dissolved organics, oils or emulsified oil from water.

Technologies from other industries, such as membrane-based technologies (polymeric and non-polymeric), are now being evaluated for the O&G industry, especially to treat PW for higher water quality for other beneficial use, including enhanced oil recovery (EOR). However, presence of even a small quantity of suspended, dissolved or emulsified oil in water can severely foul the membranes. Presence of oils can also damage the membranes, reducing water production or causing reversible or irreversible fouling to the membranes.

Commonly used adsorbents such as powder or granular activated carbon (PAC and GAC) or other types of inorganic or organic adsorbent materials (ion-exchange) or precipitation technique (coagulation) commonly used can be effective in water treatment but may not be effective for PW treatment in the O&G industry. They also can be cost prohibitive, especially for large O&G operation. The co-occurring, counter ions and other background ions (matrix effect), and organics can also interfere for these technologies.

An alternative method is thus needed that can selectively remove oil from PW, for example as pretreatment before membrane based or other alternative treatment is applied. Currently, there are no available technologies that can effectively remove the dissolved and emulsified portion of the oil effectively and economically.

### SUMMARY

A challenge in removing oil from PW is that the oil-water interface is populated by asphaltenes-organic macromolecules with polar and apolar groups—that stabilize the oil-water interface such that the interfacial tension drops from ˜50 mN/m to <1 mN/m. As a result, microscopic oil drops stay suspended in the aqueous matrix for months and years. Though the molecular structures of asphaltenes vary with geography, they are generally comprised of several aromatic and hetero-aromatic rings as well as alkyl chains as shown, for example, in the FIG. 1.

Ideally the solution should to be affordable, easy to use, easy to operate and easy to separate with the possibility of reusing the same material in a floatation or separation column. In addition, the material used should be oil selective and less impacted by background water quality.

The material provides such properties. The material can be used in the O&G industry to improve PW quality. The material can also be used in applications other than the O&G industry, including industrial, water and wastewater treatment. The material can be especially used in removing dissolved organic foulants and oily matter from water. Thus, the material proposed here can be used in many applications for easy separation and reuse, including PW treatment.

In an embodiment, the material is a functionalized mineral material. Preferably the mineral material is a silica material, for example silicon dioxide (SiO₂). However, the material can also be any material that can be silanized, such as also mica or other mineral material that can undergo a silanation reaction. By salinized we mean the covering of a mineral component, such as mica and silica (glass), through self-assembly with organofunctional alkoxysilane molecules. This can cause a chemical reaction between two silica derivatives, for example a material containing silanol groups (—Si—OH) and an organic molecule with the silane group (e.g., R—Si (OCH₂CH₃)₃). The material can be silanized because it contains hydroxyl groups which attack and displace the alkoxy groups on the silane thus forming covalent —Si—O—Si-bond. The reaction can thus form bonds across the interface between the mineral surface and the organic components. In any one or more aspects, the functionalized mineral material can have a density less than that of water to allow the material to float in water and to aid in removal of the functionalized material including dissolved organic foulants, charged contaminants and/or oily matter from the water. The floatation can facilitate oil-water separation at a lower cost.

In any one or more aspects, the material can be a functionalized microsphere. The functionalized microsphere can have a density less than that of water so the microsphere will float in water. For example, the microsphere can be a hollow microsphere providing a density less than that of water and allowing the microsphere to float in water. In an aspect, the microsphere can be in the range of 10-100 μm in diameter.

In one or more aspects, the material can be functionalized by chemical modification of the surface of the material. The material can be functionalized to attract and/or adsorb dissolved organic foulants, charged contaminants and oily matter from water. For example, the material can be commercially available hollow glass (e.g., silica, SiO₂) microspheres (e.g., 10-100 μm diameter) functionalized for separating suspended emulsified oil micro-droplets from produced water—defined as the water that comes out of an oil/gas reservoir during flooding operations and is unfit for agricultural purpose or subsequent injection in the oil-well. Commercially available unfunctionalized microspheres are typically marketed for use in (1) paint industry: for uniform spreading and reduction of abrasion, (2) rubber and plastics industry: for low weight strength additives, and (3) oil & gas industry: for durable and low cost subsea flow-lines. Salient features of SiO₂ microspheres include: (1) low cost, (2) lower density than water, (3) high mechanical strength and abrasion resistance, and (4) possibility of tailoring surface properties of SiO₂ microspheres via certain chemistries. Though, until now, there has been little investigation of the last attribute.

In an embodiment, we provide a method for tailoring or modifying the mineral material to attract and/or adsorb dissolved organic foulants, charged contaminants and oily matter from water. In any one or more aspects, the mineral material (e.g., mica and silica (such SiO2 microspheres)) can be functionalized via simple and scalable silanation reactions. In any one or more aspects the mineral material can be functionalized with hydrocarbon and/or perfluorinated species. Suitable hydrocarbon species include species having alkyl groups or alkyl chains, as defined herein, typically having 30 or fewer carbon atoms in its backbone, including for example C₃H₇ to C₁₈H₃₇ and including in particular CH₃(CH₂)₁₁. Suitable perfluorinated species include chemical species where a substantial portion of the replaceable hydrogen atoms have been replaced by fluorine atoms, as defined herein, including for example CF₃(CH₂) to CF₃(CF₂)₂₀CH₂, and including in particular CF₃(CF₂)₁₀CH₂. The hydrocarbon and/or the perfluorinated species can be grafted on the surface of the material (FIG. 2) leading to specific changes in hydrophobicity, polarizability, surface charge, and surface potential. Thus, in one or more aspects, we can transform the mineral material, such as mica and/or silica (e.g., SiO₂ microspheres), into a functionalized material for a host of new applications, such as oil-water separation in produced water (PW), removal of organics and charged contaminants from water. Herein, we will focus our discussion on application for separation in produced water, though other applications can be made.

In an embodiment, the present disclosure provides a functionalized material for use in separation of foulants, for example asphaltenes, from produced water. The functionalized material can, comprise an outer surface functionalized with an alkyl chain or a perfluorinated species, the alkyl chain or perfluorinated species selected to dissolve organic foulants, charged contaminants or oily matter, or any combination thereof, from water, such as PW.

In an embodiment, a method of making a functionalized material is provided. The method can comprise: a) providing a mineral material; b) providing an alkyl chain and/or a perfluorinated species, the alkyl chain or perfluorinated species selected to dissolve organic foulants, charged contaminants or oily matter from water or any combination thereof; c) hydroxylating the material; and d) grafting the alkyl chain and/or the perfluorinated species onto the material via a silanation reaction.

In any one or more aspects of one or more of the embodiments, the functionalized material can be a functionalized mineral material wherein the mineral material selected from the group consisting of mica and/or silica. The alkyl chain can be selected from the group consisting of alkyl chains having 30 or fewer carbon atoms in its backbone, as defined herein, including for example C₃H₇ to C₁₈H₃₇, and including in particular CH₃(CH₂) and wherein the perfluorinated species is selected from the group consisting of chemical species where a substantial portion of the replaceable hydrogen atoms have been replaced by fluorine atoms, as defined herein, including for example CF₃(CH₂)₂ to CF₃(CF₂)₂₀CH₂ and including in particular CF₃(CF₂)₁₀CH₂. The functionalized material can have a density less than that of water. The functionalized material can be a SiO₂ microsphere, and the outer surface of the microsphere functionalized with an alkyl chain. The surface of the microsphere can be functionalized with an alkyl chain, as described herein, grafted onto the microsphere. The functionalized material can be hydroxylated via an acid solution selected from the group consisting of hydrochloric acid, hydrofluoric acid, sulfuric acid, or a combination of sulfuric acid and hydrogen proxide. The material can be functionalized under basic conditions. The alkyl chain can be provided and the alkyl chain can be covalently grafted onto the functionalized material.

In an embodiment, a separation method is provided. The separation method can comprise: a) providing a functionalized material of any one or more of the aforementioned aspects; b) mixing the functionalized material with water containing a dissolved organic foulant, charged contaminant or oily matter or any combination thereof and causing the dissolved organic foulant, charged contaminant or oily matter or any combination thereof to attach to the functionalized material; c) separating the functionalized material including the dissolved organic foulant, charged contaminant or oily matter or any combination thereof from the water: and d) causing a release of the dissolved organic foulant, charged contaminant or oily matter or any combination thereof from the functionalized material. The step of separating the functionalized material can include floating the functionalized material upwardly through the water. The functionalized material including the dissolved organic foulant, charged contaminant or oily matter or any combination thereof can be introduced into a separation column and allowed to float upwardly through the separation column and/or the mixing of step (b) can be provided in the separation column. In step (d), the functionalized material including the dissolved organic foulant, charged contaminant or oily matter or any combination thereof can subjected to an external release means to cause a release of the dissolved organic foulant, charged contaminant or oily matter or any combination thereof from the functionalized material, preferably selected from the group consisting of compression, centrifugation, sonication or dissolution or combination thereof. The separation method can include addition of an organic solvent (such as toluene) to dissolve and release the dissolved organic foulant, charged contaminant or oily matter or any combination thereof from the functionalized material and thereby regenerate the functionalized material.

Other systems, methods, features, and advantages of the present disclosure, will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts the molecular structure of a typical asphalthene molecule. Several aromatic and heteroaromatic rings as well as alkyl chains are depicted as present in the asphaltene molecule.

FIG. 2 depicts a modification to a microsphere according to the present disclosure.

FIG. 3 depicts chemical reactions for surface modification of a microsphere, wherein: (i) Shows hydroxylation of SiO₂ microspheres under acidic solution, (ii) hydroxylated SiO₂ microspheres were reacted with tri-ethoxy-alkyl silanes, e.g. C-12 or C-16, and hydrocarbon units were grafted onto SiO₂ microspheres.

FIGS. 4A-C depict microsphere floatation and separation, wherein FIG. 4A depicts an initial stage in which a down-flow impeller controls the initial mixing stage of oil droplets to functionalized SiO2 spheres; FIG. 4B depicts an intermediate stage in which oil and microsphere interaction and adsorption occurs; and FIG. 4C depicts a final stage in which oil and microsphere agglomeration.

FIGS. 5A-D depict various embodiments in which emulsified oil drops adsorbed on to SiO₂ microspheres can be removed by various methods as shown: mechanical compression, FIG. 5A; centrifugation, FIG. 5B; sonication, FIG. 5C; and dissolution in an organic solvent, FIG. 5D. After removing the oil, the SiO₂ spheres can be reused.

FIG. 6 depicts a synthetic produced water after treatment with commercial, FIG. 6A, and functionalized silica hollow spheres, FIG. 6B.

FIG. 7 depicts kinetics of oil-uptake by 0.5 gm C-12 functionalized beads in 1 L of 100 ppm produced water (pw) sample.

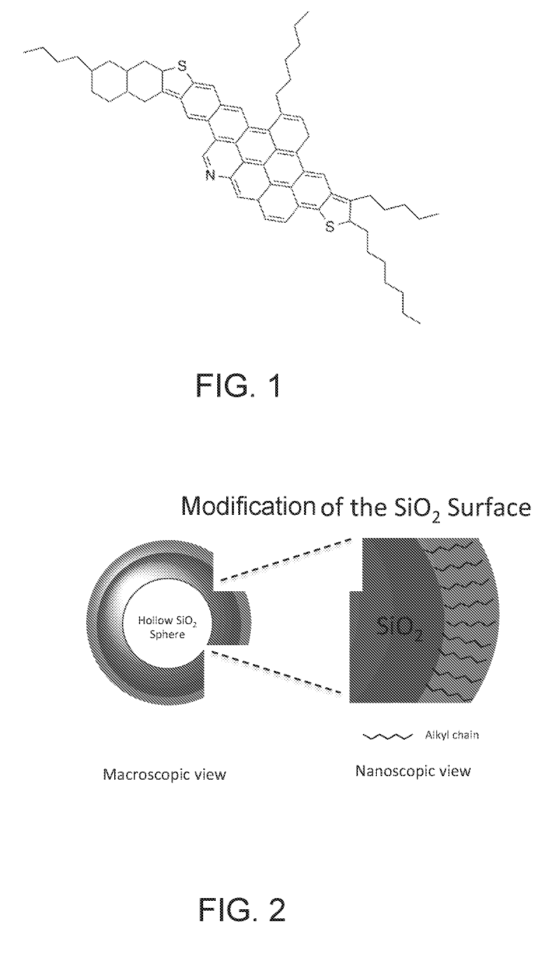

### DETAILED DESCRIPTION

Described below are various embodiments of the present functionalized material, methods of producing the functionalized material, and use thereof for separation processes such as but not limited to use for extracting oil and oil moieties from water. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

### Definitions

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

By the term “derivative” we mean any compound having the same or a similar core structure to the compound but having at least one structural difference, including substituting, deleting, and/or adding one or more atoms or functional groups. The term “derivative” does not mean that the derivative is synthesized from the parent compound either as a starting material or intermediate, although this may be the case. The term “derivative” can include salts, prodrugs, or metabolites of the parent compound. Derivatives include compounds in which free amino groups in the parent compound have been derivatized to form amine hydrochlorides, p-toluene sulfoamides, benzoxycarboamides, t-butyloxycarboamides, thiourethane-type derivatives, trifluoroacetylamides, chloroacetylamides, or formamides. Derivatives include compounds in which carboxyl groups in the parent compound have been derivatized to form salts, methyl and ethyl esters or other types of esters or hydrazides. Derivatives include compounds in which hydroxyl groups in the parent compound have been derivatized to form O-acyl or O-alkyl derivatives. Derivatives include compounds in which a hydrogen bond donating group in the parent compound is replaced with another hydrogen bond donating group such as OH, NH, or SH. Derivatives include replacing a hydrogen bond acceptor group in the parent compound with another hydrogen bond acceptor group such as esters, ethers, ketones, carbonates, tertiary amines, imine, thiones, sulfones, tertiary amides, and sulfides.

By “alkyl” or “alkyl chain” we mean the radical of saturated aliphatic groups (i.e., an alkane with one hydrogen atom removed), including straight-chain alkyl groups, branched-chain alkyl groups, cycloalkyl (alicyclic) groups, alkyl-substituted cycloalkyl groups, and cycloalkyl-substituted alkyl groups.

A straight chain or branched chain alkyl can have 30 or fewer carbon atoms in its backbone (e.g., C₁-C₃₀ for straight chains, and C₃-C₃₀ for branched chains), preferably 20 or fewer, more preferably 18 or fewer, most preferably 12 to 16 carbon atoms. Likewise, preferred cycloalkyls have 3-10 carbon atoms in their ring structure, and more preferably have 5, 6, or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, phosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

It will be understood by those skilled in the art that the moieties substituted on the hydrocarbon chain can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

By “heteroalkyl”, as used herein, we mean straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

By “asphaltenes”, we mean molecular substances that are found in crude oil, along with resins, aromatic hydrocarbons, and saturates (i.e. saturated hydrocarbons such as alkanes) that consist primarily of carbon, hydrogen, nitrogen, oxygen, and sulfur, as well as trace amounts of vanadium and nickel. The C:H ratio can be approximately 1:1.2, depending on the asphaltene source. Asphaltenes are defined operationally as the n-heptane (C₇H₁₆)-insoluble, toluene (C₆H₅CH₃)-soluble component of a carbonaceous material such as crude oil bitumen, or coal.

By “functionalized”, we mean having one or more functional group or moieties attached covalently or non-covalently thereto, preferably covalently. Suitable functional groups can include alkyl group and substituted alkyl groups such as perfluorinated alkyl groups.

By “hydroxylated” or “hydroxylation”, we mean the presence of hydroxyl groups (—OH) in one material (or molecule) and chemical reaction that allows the formation of (the) hydroxyl group(s) in one material (or molecule), respectively.

By “perfluorinated species”, we mean a chemical species where all, essentially all or a substantial portion, e.g. at least about 40%, 50%, 60%, 70%, 80%, or 90%, or more, of the replaceable hydrogen atoms have been replaced by fluorine atoms. Suitable perfluorinated species can include perfluorinated alkyl chains such as perfluorinated straight-chain alkyl groups, perfluorinated branched-chain alkyl groups, perfluorinated cycloalkyl (alicyclic) groups, perfluorinated alkyl-substituted cycloalkyl groups, and perfluorinated cycloalkyl-substituted alkyl groups. Suitable perfluorinated species can consist of perfluorinated alkyl and heteroalkyl groups having 2 to 20 carbon atoms. Suitable perfluorinated species can include CF₃(CH₂)₂ to CF₃(CF₂)₂₀CH₂.

By “produced water” (PW), we mean water that comes out of an oil/gas reservoir during flooding operations and is unfit for agricultural purpose or subsequent injection in an oil-well.

By “silanation”, we mean chemical reactions between two silica derivatives, usually a material containing silanol groups (—Si—OH) and an organic molecule with the silane group (e.g. R—Si(OCH₂CH₃)₃). In some embodiments R is an alkyl chain or a perfluorinated alkyl chain.

### Description

In an embodiment, we provide a functionalized mineral material for use in attracting and separating dissolved organic foulants, charged contaminants and oily matter from water, for example produced water. In an aspect, the functionalized mineral material is a mica and/or silica. In an aspect, the silica material can be a functionalized SiO₂ microsphere. The mineral material can have a density less than that of water, allowing the material to float in water. In an aspect, material can be a hollow SiO₂ the microsphere having a diameter in the range of 10-100 μm.

In any one or more aspects the mineral material can be functionalized with alkyl chains and/or perfluorinated species. For example, the material can be an SiO₂ microsphere functionalized with alkyl chains and/or perfluorinated species.

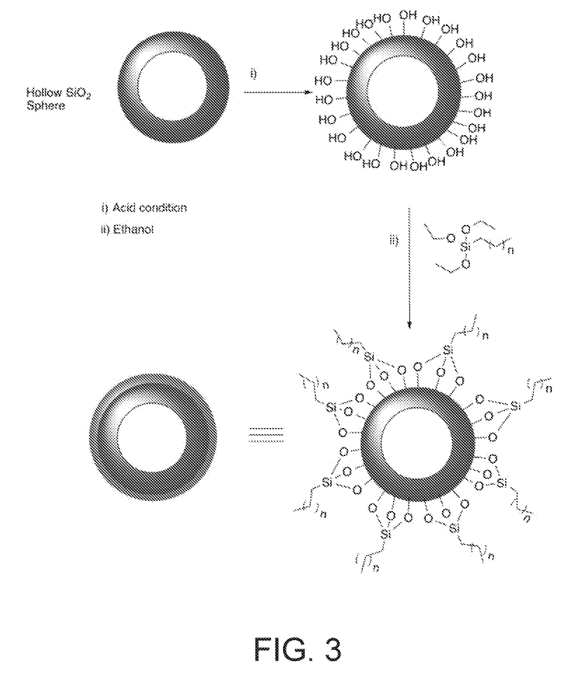

In an embodiment we provide methods of functionalizing the mineral material. Hydroxylation can be performed under acidic conditions to form silanol groups. In an aspect, the mineral material can be hydroxylated via concentrated hydrochloric acid solution (˜pH 1). Subsequently, hydrocarbon chains can be covalently grafted onto the mineral material via silanation reactions (See, e.g., FIG. 3). The covalent bonds thus formed will be strong (˜100 kcal/mol) and durable. A wide variety of acidic solutions can be employed, such as piranha solution (Sulfuric acid and hydrogen peroxide), sulfuric acid, hydrochloric acid, and hydrofluoric acid. The silanol formation could also be achieved under basic conditions, such as in NaOH solution.

In an embodiment, we provide methods of use of the functionalized mineral material. For example, we provide methods of use of a functionalized microsphere for use in a separation process. The functionalized microsphere can be exposed to produced water (PW). Oil-phase in the PW can preferentially be attracted to, be adsorbed by and/or agglomerate on to the functionalized microspheres. Since SiO₂ microspheres, in particular hollow SiO₂ microspheres, are lighter than water, the droplets of emulsified oil bound to the functionalized microspheres will float upward along with them. Subsequently, the oil laden mineral material can be subjected to external means, such as compression, centrifugation, sonication, or dissolution, or a combination thereof, to break the asphaltenic coating and release the oil from the functionalized microspheres and regenerate the functionalized microspheres for reuse.

Due to specific interaction forces (van der Waals, hydrophobic interactions, and π-stacking), asphaltenes coated oil drops will attach to the functionalized mineral material (e.g., SiO₂ microspheres). Thus, when the functionalized mineral material is exposed to produced water, emulsified oil drops will be adsorbed onto them.

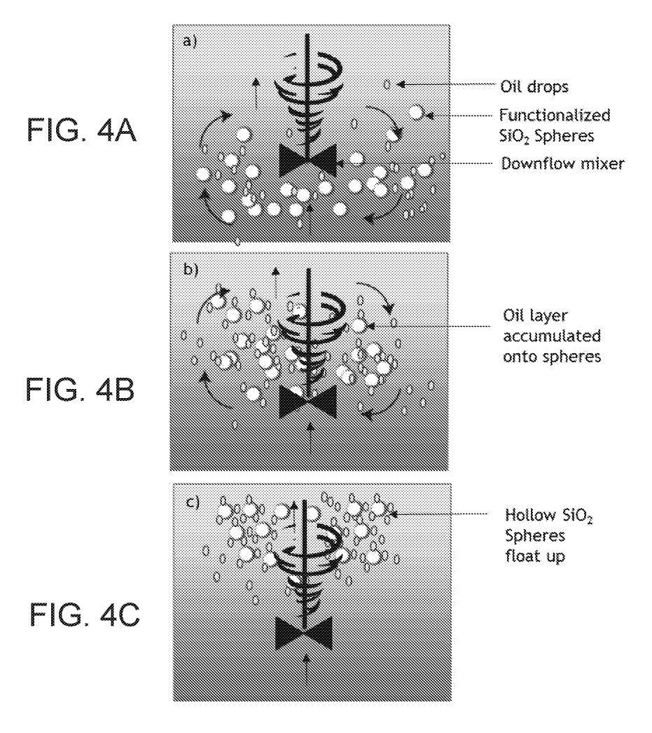

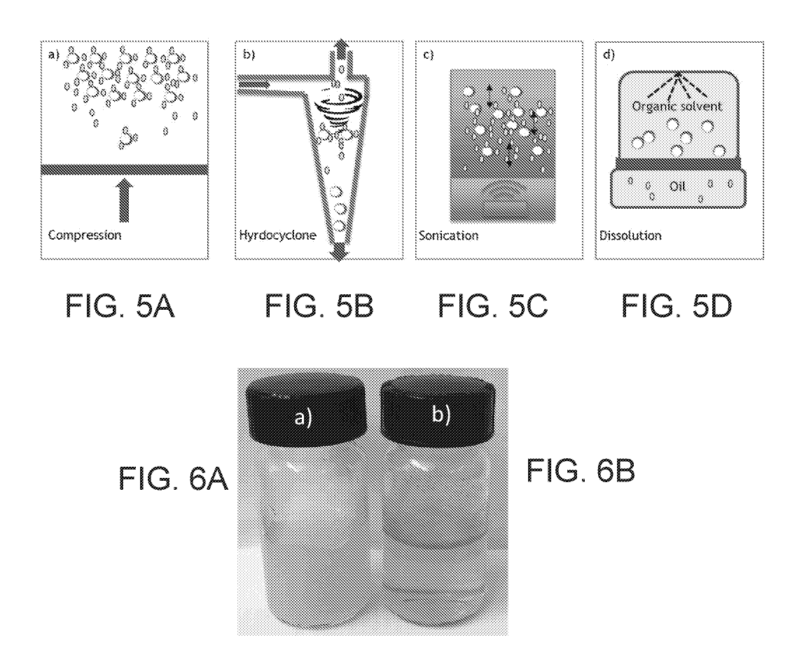

Mechanical means can be provided to assist in controlling mixing of the PW and the functionalized mineral material. For example, a mechanical down-flow impeller can be provided to control the upwards flow of microspheres through the Produced Water for optimal interactions between Produced Water and the functionalized mineral material. As an initial stage the down-flow impeller can be used to control the mixing of oil droplets and the functionalized mineral material (such as mica and/or silica, e.g., SiO₂ microspheres) (FIG. 4A). Oil and mineral material interaction and adsorption can occur resulting in oil and mineral material agglomeration (FIG. 4B). In an aspect, the functionalized mineral material and Produced Water can be introduced into a separation column. The mechanical mixing can be provided in the column. The functionalized mineral material can be allowed to float up (FIG. 4C) and exit the separation column for the next phase of treatment (see, e.g., FIGS. 5A-5D).

Oil can then be separated from the emulsified oil laden mineral material (e.g., SiO₂ microspheres). This can be accomplished by a variety of methods, physical or chemical, e.g. compression by air or a mechanical plunger, centrifugation, or ultra-sonication to rupture the asphaltene layer to release oil. (FIGS. 5A-D). Addition of organic solvents to dissolve asphaltenes, such as toluene, is also a possibility. After this phase the functionalized mineral material can be recovered and introduced back into the floatation system (for example a separation or floatation column) for regeneration of the functionalized material and reuse.

### EXAMPLES

A synthetic Produced Water sample was prepared by mixing 150 mg of crude oil in de-ionized (DI) water. Typical size of emulsified oil drops ranged from 4-30 μm. As a control test, commercial SiO₂ microspheres were immersed in the solution and stirred for 10 minutes at 60 rpm. No oil was removed as demonstrated by the murkiness of the solution and microspheres as shown in vial (a) of FIG. 6A. However, when SiO₂ microspheres with C-12 hydrocarbon chains grafted onto them were introduced in a synthetic Produced Water sample, a dramatic uptake of the emulsified oil was observed as evidenced by the clarity of the solution in vial (b) of FIG. 6B. Oil adsorbed SiO₂ microspheres were separated from the treated PW and the oil was extracted using hexane recovering the SiO₂ microspheres.

Subsequently, we increased the salinity of the simulated Produced Water to 0.2 M and found the uptake of functionalized SiO₂ microspheres (with C-12 hydrocarbon chains) to increase.

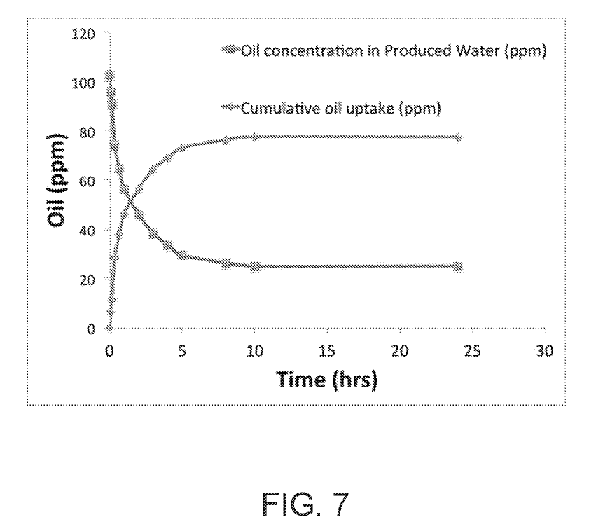

In another experiment, simulated Produced Water was prepared using a light crude oil (density=0.861 g/ml) at 100 ppm concentration without any surfactants. Subsequently, 1 L of this solution was incubated with 0.5 gm of C-12 functionalized silica microbeads and aliquots were taken to perform a kinetics study. After about 5 hours, the uptake was saturated. (FIG. 7).

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A functionalized material, comprising:
an outer surface functionalized with an alkyl chain or a perfluorinated species, wherein the alkyl chain or perfluorinated species attracts one or more of organic foulants, charged contaminants, and oily matter from water.

2. The functionalized material of claim 1, wherein the functionalized material is one or more of mica and silica.

3. The functionalized material of claim 1, wherein the alkyl chain is substituted or unsubstituted alkyl or heteroalkyl groups having 30 or fewer carbon atoms and derivatives thereof, and wherein the perfluorinated species is one or more of perfluorinated alkyl and heteroalkyl groups having from 2 to 20 carbon atoms.

4. The functionalized material of claim 1, wherein the functionalized material has a density less than that of water.

5. The functionalized material of claim 1, wherein the functionalized material is a SiO₂ microsphere, and the outer surface of the microsphere is functionalized with an alkyl chain.

6. The functionalized material of claim 1, wherein the surface of the functionalized material is functionalized with a C₃-C₁₈ hydrocarbon chain grafted onto the microsphere.

7. A method of making a functionalized material, comprising:
hydroxylating a mineral material;
grafting one or more of an alkyl chain and a perfluorinated species onto a surface of the mineral material via a silanation reaction;

8. The method of claim 7, wherein, the mineral material is selected from the group consisting of mica and silica.

9. The method of claim 7, wherein the alkyl chain is a substituted or unsubstituted alkyl or heteroalkyl groups having 30 or fewer carbon atoms and derivatives thereof, and wherein the perfluorinated species is a perfluorinated alkyl and heteroalkyl groups having from 2 to 20 carbon atoms.

10. The method of claim 7, wherein the functionalized material has a density less than that of water.

11. The method of claim 7, wherein the functionalized material is a SiO₂ microsphere, and the outer surface of the microsphere is functionalized with an alkyl chain.

12. The method of claim 7, wherein the surface of the microsphere is functionalized with a C₃-C₁₈ hydrocarbon chain grafted onto the microsphere.

13. The method of claim 7, wherein the material is hydroxylated via an acid solution, wherein the acid solution includes one or more of hydrochloric acid, hydro fluoric acid, sulfuric acid, and hydrogen proxide.

14. The method of claim 7, wherein the material is functionalized under basic conditions.

15. The method of claim 7, wherein the alkyl chain is covalently grafted onto the functionalized material.

16. A separation method, comprising:
mixing a functionalized mineral material with water containing one or more chemical species sufficient to attach one or more of the chemical species to the functionalized mineral material,
wherein the functionalized mineral material is grafted with one or more of an alkyl chain and perfluorinated species, wherein the chemical species include one or more of a dissolved organic foulant, charged contaminant, and oily matter; and
separating the functionalized mineral material from the water; and
releasing one or more of the attached chemical species from the functionalized mineral material.

17. The separation method of claim 16, wherein the step of separating the functionalized mineral material includes floating the functionalized mineral material upwardly through the water.

18. The separation method of claim 16, wherein the step of mixing occurs in a separation column and the step of separating the functionalized mineral material includes floating the functionalized mineral material upwardly through the separation column.

19. The separation method of claim 16, wherein the step of releasing includes one or more of compression, centrifugation, sonication, and dissolution.

20. The separation method of claim 16, wherein the step of releasing includes adding an organic solvent.
